(19) United States
(12) Patent Application Publication
(10) Pub. No.: US 2007/0207318 A1
(43) Pub. Date: Sep. 6, 2007

(54) Catalytically Grown Mano-Bent Nanostructure and Method for Making the Same

(76) Inventors: Sungho Jin, San Diego, CA (US); Li-Han Chen, San Diego, CA (US); Joseph F. AuBuchon, La Jolla, CA (US)

Correspondence Address: Sanford Astor;Lewis Brisbois Bisgaard Smith, 221 N Figueroa Street, Suite 1200, Los Angeles, CA, 90012, US

(21) Appl. No.: 11/632,688

(22) PCT Filed: Jul. 20, 2005
(86) PCT No.: PCT/US05/25763

§ 371 Date: Jan. 17, 2007

Related U.S. Application Data
(60) Provisional application No. 60/589,838, filed on Jul. 21, 2004.

(51) Int. Cl. H05H 1/24; B32B 9/00

(52) U.S. Cl. 428/408; 427/569

(57) ABSTRACT

Elongated nanostructures and a method of fabricating elongated nanostructures with one or more sharp A bends using a plasma enhanced chemical vapor deposition process comprising placing an anode above the nanostructure and a cathode below the nanostructure, applying a voltage between the anode and cathode to create electric field lines, and changing the direction of the electric field lines during the fabrication of the nanostructure. Device applications using such structures are also disclosed.

### FIELD OF THE INVENTION

The present invention relates to the engineering of bends in high-aspect-ratio nanostructures, in particular, catalytically grown carbon nanotubes containing multiple sharp bends.

### BACKGROUND OF THE INVENTION

Since their discovery carbon nanotubes (CNTs) have been studied for many different applications because of their exceptional electrical and mechanical properties. Carbon nanotubes have already been shown to be useful for a variety of applications, such as field emission devices, nano-scale electromechanical actuators, field-effect transistors (FETs), CNT based random access memory (RAM), and atomic force microscope (AFM) probes. There has also been much work demonstrating CNTs potential as nano-interconnects, including showing no obvious degradation after 350 hours in the current carrying capacities of multiwalled CNTs (MWNTs) at very high current densities of 10¹⁰ A/cm², the manufacture of deterministic CNT wiring networks, and using an electron beam to form mechanical connections between two nanotubes.

In order to utilize CNTs as interconnects and other device components, the ability to control their growth morphology is desired. The growth of vertically aligned MWNTs has been demonstrated by several groups using plasma enhanced chemical vapor deposition (PECVD). See articles by Ren, et al., “Synthesis of large arrays of well-aligned carbon nanotubes on glass”, Science 282, page 1105 (1998), by Bower, et al., “Plasma-induced alignment of carbon nanotubes”, Appl. Phys. Lett., 77, 830-832 (2000), and “Nucleation and growth of carbon nanotubes by microwave plasma chemical vapor deposition”, Appl. Phys. Lett., 77, 2767-2769 (2000), and by Merkulov, et al., “Alignment Mechanism of Carbon Nanofibers Produced by Plasma-Enhanced Chemical-Vapor Deposition”. Appl. Phys. Lett. 79, 2970-2972 (2001).

These results all had CNTs aligned perpendicular to a substrate surface due to the applied field or electrical self-bias field created by-the plasma environment. The linear aligned growth of CNTs by electric field in other directions, such as in-plane directions, has been demonstrated both for single walled carbon nanotubes (SWNTs) and MWNTs.

Although alignment of individual CNTs and CNT arrays has been demonstrated, there has been very little work done towards more complicated morphologies. Merkulov et. al. showed a fabrication of bent CNTs consisting of one section perpendicular to a substrate and a second section aligned ˜45° off of the substrate normal with radii of curvature on the order of 1 μm. The off-normal growth was achieved by positioning the sample near the edge of the sample holder where bending of the electric field lines occurs. This invention shows the ability to grow CNTs with sharp bends that maintain a constant tube diameter before and after a bend and the ability to grow structures with multiple bends resulting in a zigzag morphology. Zigzag structured or signally bent CNTs could be used for many applications, e.g., related to mechanical nanosprings, atomic force microscope (AFM) probes, or complicated circuit nano-interconnections.

### SUMMARY OF THE INVENTION

This invention includes novel elongated nanostructures attached on a substrate, with one or more bends, methods for engineering such bent nanostructures with sharp radii of curvature of preferably less than 100 nm, and devices comprising such nanostructures for applications such as nano interconnections, nano circuit components, nano heterojunction semiconductors, nano solenoids, nano springs and various nano-manipulators/nano-actuators, nano probes for characterization of surface topography, nano conductance, nanomagnetics, nano-writing/nano-patterning, and nano machining. This invention allows for the synthesis of structures with multiple sharp bends i.e. zigzag morphology, box helixes, nano solenoids and others.

### BRIEF DESCRIPTION OF THE DRAWINGS

The advantages, nature, and additional features of the invention will appear more fully upon consideration of the illustrative embodiments described in the accompanying drawings. It is to be understood that these drawings are for purposes of illustrating the concepts of the invention and are not to scale. In the drawings:

FIG. 1 illustrates a schematic view of a cathode with a sample substrate positioned in a recessed corner;

FIGS. 2A and 2B illustrate schematic views of recessed corner cathode configurations formed by positioning part of the cathode directly on the substrate,; FIGS. 3A and 3B illustrate views of nanostructures grown perpendicular to the local surface while positioned on a flat cathode (3A) [prior art], and nanostructures grown at a significant angle displaced from perpendicular to the substrate surface when grown in a recessed corner cathode configuration (3B);

FIG. 4A illustrates a schematic view of changing the cathode geometry by rotating part of the cathode around a section of a substrate;

FIGS. 4B, 4C, and 4D illustrate schematic views of three of the possible resulting structures of zig-zag nanowire, box helix, and nano solenoid, respectively, made by using the construction of 4A;

FIGS. 5A and 5B illustrate views of nanostructures with multiple sharp bends obtained by changing the location of the recessed corner cathode configuration;

FIG. 6A illustrates a bent carbon nanotube attached for AFM probe applications;

FIG. 6B shows a bent carbon nanotube directly grown from the AFM pyramid tip;

FIG. 6C shows an exemplary 90 degree bent nanotubes;

FIG. 6D illustrates an example of side-wall probing AFM tip according to the invention; and,

FIG. 7 illustrates a schematic view of (a) a zigzag nanostructure used as vertically compliant interconnections, (b) a 90 degree bending zig-zag spring for vertically compliant interconnections, and (c) in-plane bent nanowires for circuit interconnections.

### DETAILED DESCRIPTION OF THE INVENTION

This invention and the various features and advantageous details thereof are explained more fully with reference to the exemplary embodiments that are illustrated in the accompanying drawings and detailed in the following description. Descriptions of well known starting materials, processing techniques, components, and equipment are omitted so as not to obscure the invention in detail. It should be understood however, that the detailed description and the specific examples, while indicating preferred embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

This invention includes one or more elongated nanostructures having at least one sharp bend that has a radius of curvature less than 100 nm. The nanostructured material can be carbon nanotubes or other electrically conducting nanowires such as metallic nanowires, doped Si, GaN, etc., and can have either a solid or tube shape nanowires. The diameter of the inventive nanostructure is in the range of 1-500 mn, preferentially 1-100 nm. This invention includes a sharply bent nanostructure with a radius of curvature of bend of, preferably less than 100 nm radius of curvature.

This invention also includes methods of making nanostructures with sharp bends described above, either by a repeated movement of field-concentrating metal blocks or by a continuous and controlled rotation/movement of the metal blocks during deposition of nanostructures. The invention can also include apparatus for making nanostructures with sharp bends described above. The invention also includes devices comprising such bent nanostructures.

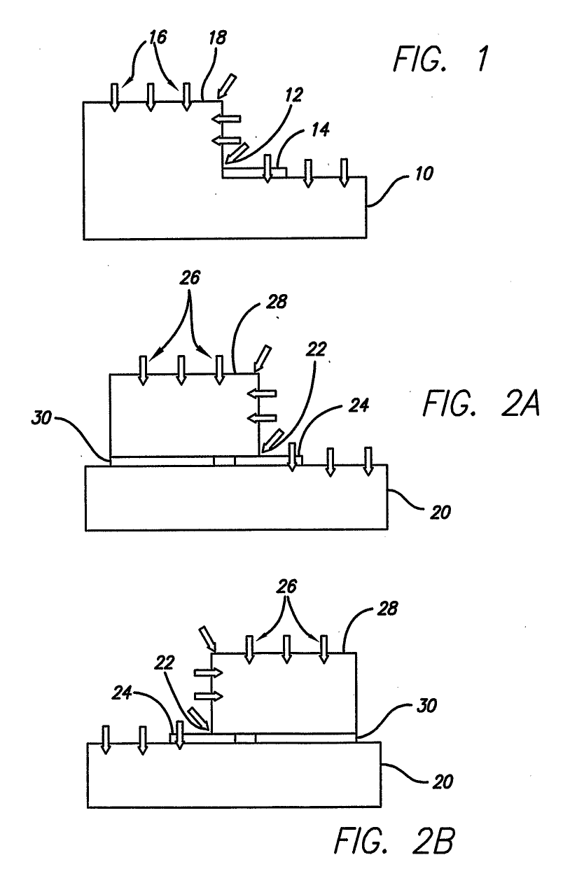

FIG. 1 depicts a schematic view of a metal block 10 containing a recessed corner 12. Metal block 10, for example, is the cathode in a direct current plasma enhanced chemical vapor deposition (DC PECVD) system. A sample substrate 14 is positioned in recessed corner 12 of this cathode. Electric field vectors 16 near the surface 18 of cathode 10 are illustrated by block arrows. The electric field vectors 16 are perpendicular to the local surface 18 at all points of the cathode. The electric field lines 16 do bend at distances away from the cathode surface 18 and eventually terminate perpendicular to the surface of the anode.

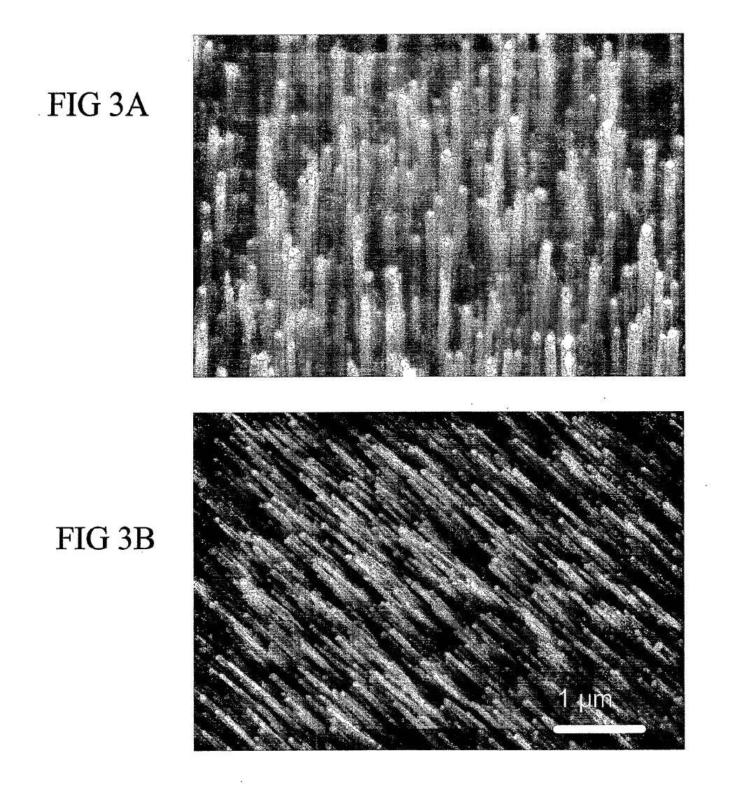

FIGS. 2A and 2B depict a schematic view of a metal block 20 containing a recessed corner 22. Metal block 20, for example, is the cathode in a direct current plasma enhanced chemical vapor deposition (DC PECVD) system. A sample substrate 24 is positioned in recessed corner 22 of this cathode. Electric field vectors 26 near the surface 28 of cathode 20 are illustrated by block arrows. The electric field vectors 26 are perpendicular to the local surface 28 at all points of the cathode. The electric field lines 26 do bend at distances away from the cathode surface 28 and eventually terminate perpendicular to the surface of the anode. An electrical conductor 30 is adjacent substrate 24.

In the absence of an applied DC bias, CNT growth in a microwave plasma environment has been shown to produce CNTs aligned perpendicular to the substrate. The plasma environment creates a potential self-bias where the field lines are always perpendicular to the surface. Even when a substrate's surface is tilted at any angle, the field lines will bend and, within a narrow region (less than 10 μm above substrate surface where CNT growth occurs), the field lines will always be straight and perpendicular to the surface.

FIG. 3A illustrates a prior art nanostructures grown on a flat section of a cathode. The resulting structures are aligned perpendicular to the local substrate surface. To cause bending in the CNTs, the electric field must be manipulated in such a way that the field lines in the growth region of the CNTs are bent. Growth along field lines at angles not perpendicular to the substrate surface has previously been achieved by positioning the sample near the sharp cornered edge of the sample stage (near the protruding corner of the conducting stage) where the field lines are bent toward that sharp corner direction, even at distances within the growth region. However, with such a field from the protruding corner, a sharp bend in the nanotubes cannot be achieved.

With this invention, a recessed corner cathode geometry caused very large and dramatic changes in the direction of the electric field lines in the CNT growth region. The resulting electric field lines are bent dramatically, and even for distances 10 nm above the surface, the resulting nanostructures are grown aligned at angles greatly tilted from perpendicular to the surface. By changing the cathode geometry, multiple growth segments are made connected by sharp bends with radii of curvature under 100 nm. FIG. 3B illustrates nanostructures grown in such a recessed corner cathode configuration. The resulting nanostructures are aligned at an angle that is clearly strongly displaced from perpendicular to the local surface.

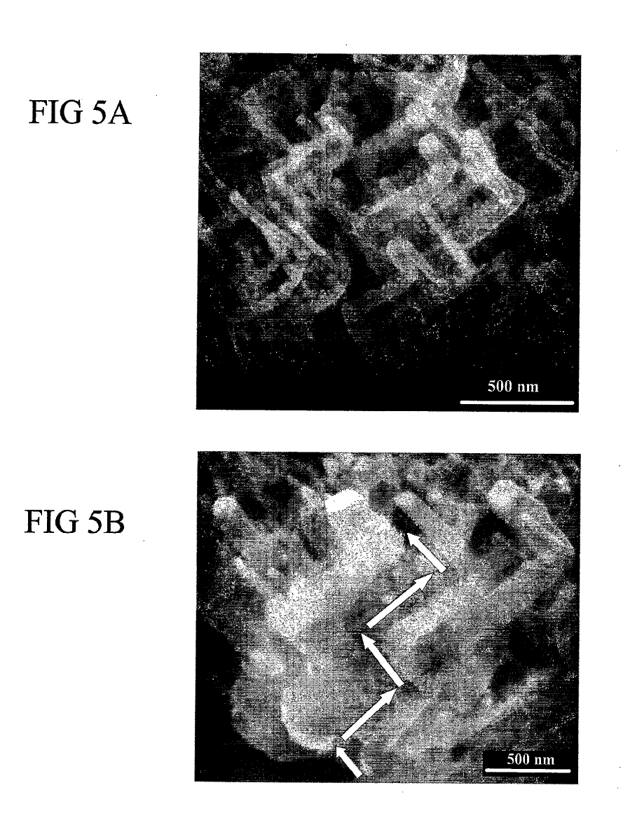

FIGS. 2A and 2B illustrate recessed corner cathode geometries that have mirror images. By alternating between these two geometries, nanostructures with multiple sharp bends can be synthesized. FIGS. 5A and 5B illustrate scanning electron microscopy (SEM) images of zigzag nanostructures containing multiple sharp bends.

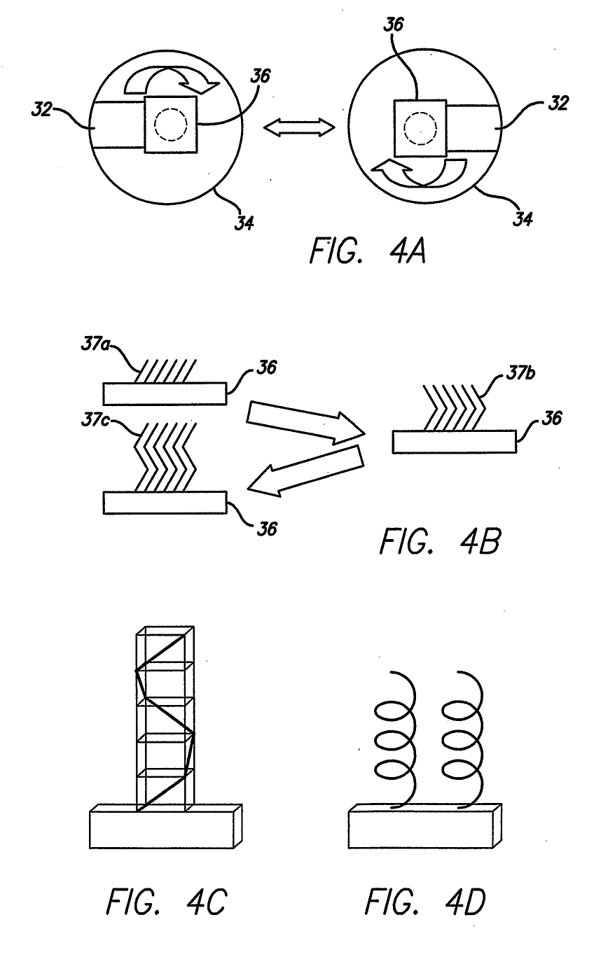

This changing of cathode geometry can be accomplished by moving a metal block in electrical contact with the cathode relative to a substrate. Such movement could be accomplished, as shown in FIG. 4A, by positioning metal block 32 on a circular ring 34 that is allowed to rotate with the sample 36 on the rotating block 32. A repeated rotation of this sort, of 180 degrees, would result in the change of cathode configurations illustrated in FIGS. 2A and 2B, and a formation of a zig-zag nanowire 37a, 37b, and 37c illustrated in FIG. 4B. Such an apparatus can also be made to rotate 90 degrees and result in a nanostructure with a box helix structure illustrated schematically in FIG. 4C. Such an apparatus can also rotate continuously at various speeds and result in true helical nanostructures or nano solenoid (FIG. 4D) of various diameters controlled by the rotation speed and growth rate.

Arrays of carbon nanotubes (CNTs) with zig-zag morphology were grown using a DC plasma enhanced chemical vapor deposition (PECVD) process using Ni catalyst particles with a tip-growth mechanism, and a mixed gas of ammonia (NH₃) and acetylene (C₂H₂). The arrays had a density of ˜2×10⁹CNTs/cm². They were fabricated by first sputter depositing a 50 A° M film over the surface of an n-type Si (100) substrate. The substrates were then transferred (in air) to a CVD chamber. Upon heating to ˜780° C., the Ni film breaks up into islands with average diameters of 30-40 nm. A DC bias of 550V was applied between an anode above the sample and a cathode just below the sample. Under the applied voltage, plasma formed and acetylene (C₂H₂) was added to the chamber flowing at 30 sccm with the total NH₃ & C₂H₂ pressure held at 3 torr.

Electric-field-concentrating metal plates (Molybdenum slabs) 1 mm thick (the same stock as the cathode stage) were placed in electrical contact with the cathode in the vicinity of the Si substrate in two different geometries (FIG. 2). Any other conductor blocks can also be used instead of Mo blocks. After the first growth stage was carried out resulting in CNTs grown at an inclined angle (aligned away from the sample edge) in the area 100-200 μm from that sample edge, the location of the Mo slabs was changed and the above process was repeated to result in the second growth stage where the nanotubes continued to grow but aligned in a direction towards the edge of the sample. These two growth stages were repeated to result in CNTs with multiple bends. For microstructural analysis, field emission scanning electron microscopy (SEM) was performed using a Phillips ESEM operated at 30 kV.

In the absence of an applied DC bias, CNT growth in a microwave plasma environment has been shown to produce CNTs aligned perpendicular to the substrate. The plasma environment creates a potential self-bias where the field lines are always perpendicular to the surface. Even when a substrate's surface is tilted at any angle, the field lines will bend, and within a narrow region (less than 10 μm above substrate surface where CNT growth occurs) the field lines will be always be straight and perpendicular to the surface. It has been estimated, for a microwave plasma environment with no applied DC field, that the self bias potential is on the order of 10V and the electric field has a magnitude on the order of 0.1 V/μm in the vicinity of the surface.

The application of a standard DC potential bias results in a different electric field around the sample. In this invention, the sample substrate is located on the cathode, which results in the direction of the applied bias being towards the sample. The field lines will always be perpendicular to the local surface and will bend as they move away from the surface to connect the two poles of the applied field. Within the region close to the sample surface where CNT growth occurs, the field lines will be straight and perpendicular to the surface, which results in vertically aligned CNTs, such as those shown in FIG. 3A. The alignment mechanism for CNTs in such a DC field is likely due to stresses created at the interface of the catalyst particle and CNT by the electric field. This mechanism provides one possible reason why tubes that grow with the catalyst particle at the top of the tube (tip-growth) are aligned, although this does not apply to nanotube alignment with the bottom-growth. CNTs are expected to grow along the field line directions, thus are expected to bend with those lines if they were to grow sufficiently long. The true net electric field is a combination of several parts, including the applied bias and the plasma induced self-bias.

In order to cause bending in the CNTs, it is necessary to manipulate the electric field such that the field lines in the growth region of the CNTs are bent. Growth along field lines at angles not perpendicular to the substrate surface has been achieved by positioning the sample near the sharp cornered edge of the sample stage where the field lines are bent towards that sharp corner direction even at distances within the growth region. However, the use of such a protruding corner field direction does not easily allow fabrication of sharply bent nanotubes.

In this invention, a different geometry was used that allowed for the presence of electric-field-concentrating metal plates to cause very large and dramatic changes in the direction of the electric field lines in the CNT growth region. The metal plates were made of the same material as the cathode stage, and were given the same potential. The resulting electric field lines in the recessed corner were bent dramatically and even for distances ˜10 nm above the surface, the resulting CNTs were grown aligned at angles greatly tilted from a perpendicular direction (to the surface). By moving the metal plates, it was possible to again dramatically alter the direction of the electric field lines, which is how sharp bends were obtained.

An SEM image of three-step zig-zag CNTs obtained by using the conductor plate arrangement of FIGS. 1 and 2 is shown in FIG. 5A. The image shows that arrays of carbon nanotubes with an average diameter of ˜30 nm were grown, aligned at an angle ˜570 from normal, then bent ˜90° and continued to grow as an aligned array until they were again bent ˜90° and grown along the original growth direction. Each straight segment in the bent nanotubes is on the order of ˜500 nm in length. The two opposing ˜90° bends are in-plane. The sample was grown two additional steps to produce five-step zig-zag tubes with four alternating opposing in-plane bends, as shown in FIG. 5B.

The bends present between two growth stages have small radii of curvature of only ˜25 nm. These nanoscale bend angles, obtained using a recessed corner of metal blocks in contact, are much sharper than micrometer scale bends previously demonstrated an open (convex) corner of a metal plate. While the nanotubes have a variation of diameter determined by the initial size of the catalyst particle formed upon heating, each individual tube shows essentially the same diameter for all growth stages.

The zig-zag nanotubes of this invention can be grown through a tip-growth process or a bottom growth process. The bends are in-plane bends (in a three dimensional sense, moving away from the substrate, not on the substrate plane). This was done to simplify the set-up geometry and to make it easier to see the resulting structures. Using similar set-ups, one can engineer out of plane bends and make more complicated three dimensional structures such as, nanocoils, segmental helixes, box-helixes, or horizontal-vertical 90 degree zig-zag shapes. Motorized rotational movement and stepper-motor movement of field-concentrating-metal plates with respect to the substrate (as illustrated in FIG. 4A) can be designed to continuously grow a complex CNT shape as is shown in FIGS. 5A and B.

Due to their small diameter, carbon nanotubes are potentially useful as a sharp probe for atomic force microscopy (AFM). The resolution of AFM imaging is determined by the sharpness, size and shape of the probe tip.

Typical commercially available AFM probe tips are made of silicon or silicon nitride (Si₃N₄) which is microfabricated into a pyramid configuration. Such probes have a typical tip radius of curvature in the ˜50 nm regime thus exhibiting a limited lateral resolution, and their rigid pyramid shape does not allow easy access to narrow or deep structural features.

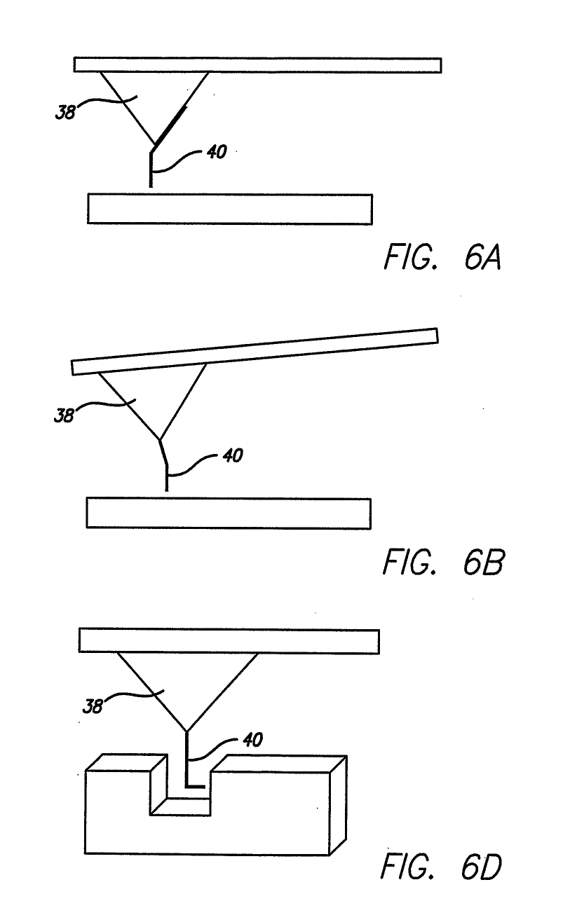

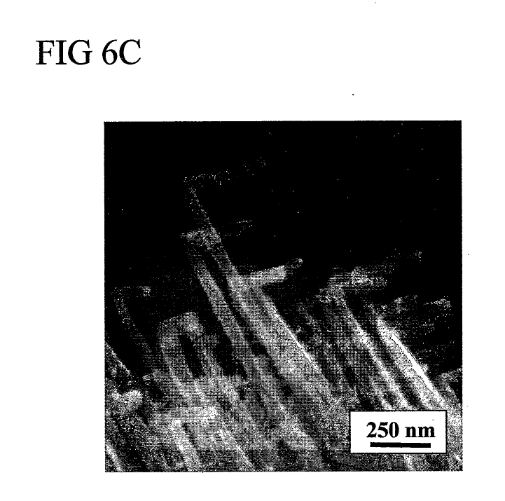

Referring to FIG. 6A, a bent CNT 40 can be utilized as a sharp probe tip that can be attached to an AFM tip with the bent portion (e.g., 60° bent) providing a sufficient contact length for enhanced bonding to the AFM pyramid 38 sidewall, while the vertically straight, protruding portion serves as a high-resolution, nanotube scanning probe tip. A variety of bonding techniques may be used to attach a sharply bent nanotube onto the AFM pyramid, e.g., electric arc welding, adhesives, solders, thin film metal deposition, or nanotube retaining carbon-deposition by e-beam in SEM. Unlike the case of awkward CNT bonding at an angle to the inclined sidewall of Si pyramid tip, such a strongly bonded nanotube probe tip with desired bend angle can provide better reliability and longer life.

An alternative way of placing the bent nanotube probe on the AFM pyramid, according to the invention, is to directly grow the aligned and bent nanotube by CVD. processing, as illustrated in FIG. 6B. One or more nanotube-nucleating catalyst particles such as made of Ni, Fe, Co or their alloys can be utilized for nucleation and growth of a carbon nanotube from the AFM pyramid tip during CVD processing. For example, a localized particle deposition near the apex of the pyramid via tip wetting with a particle-containing slurry can be utilized. A localized thin film deposition of the catalyst metal near the Pyramid tip by sputtering, evaporation, chemical or electrochemical deposition may also be utilized since a thin film can be made to ball up into a catalyst particle by heating to a high temperature such as to the CVD temperature. The bent probe tip of FIG. 6B is convenient for various applications, for example, to compensate for the tilted probe arm position onto which the nanotip probe is mounted. AFM and other probes are often operated in a tilted arm configuration for easy and reliable access to the location to be probed.

The bent nanoprobe structures of FIG. 6A and FIG. 6B can be useful for a variety of passive and active probe functions. Some examples include a probe tip applications such as atomic force microscopy (AFM), magnetic force microscopy (MFM) by coating of the probe with magnetic materials, scanning probe microscopy (SPM), or a nanowriter probe for creation of localized bit memory such as magnetically recorded bits, magneto-optical bits, electron beam ablation written bits, thermally actuated written bits (e.g., by heated probe tip causing a partial melting of a spot on the substrate), or mechanically indented bits. For example, a sharp magnetic nanowire can be placed in the nano solenoid prepared by the invention described here, and electrical current supplied so as to create sufficient magnetic field at the nanowire tip for magnetic polarity switching on a local spot of magnetic recording media surface. The nanosolenoid can also be used as a resistive heater or an inductive actuator to move the magnetic core up or down. The bent carbon nanotube tip can be utilized as electron field emitter tip with applied electric field, which can either expose an e-beam sensitive resist layer or cause local heating on the susbstrate surface to cause melting or ablation to perform nano patterning or nano writing.

A sharply bent nanotube such as shown in FIG. 6C as 90 degree bent carbon nanotubes is useful for convenient accessing of ordinally difficult to access geometries such as a vertical nanocavity or imaging of a steep side wall for metrology, electrical conductivity, magnetic property measurement, acoustic or microwave properties, etc. An example of such a device is illustrated in FIG. 6D. For electrical conductivity measurement on local regions on the steep wall, at least two bent nanotube probes can be used side by side.

The desired sharpness of the bend for the probe type application of the sharply bent nanotube according to the invention is typically in the range of 2-500 nm radius of curvature at the bend, preferably less than 100-200 nm, even more preferentially less than 50 nm radius of curvature. The desired diameter of the bent nanotubes is in the range of 1-500 mn, preferably 1-100 nm. The bent nanotube can be an equal-diameter nanotube or alternatively, it can be a tapered diameter nanotube with the diameter gradually decreasing toward the nanotube tip end. The desired length of the bent nanotubes is in the range of 0.1-100 micrometer, preferably in the range of 0.2-10 micrometer.

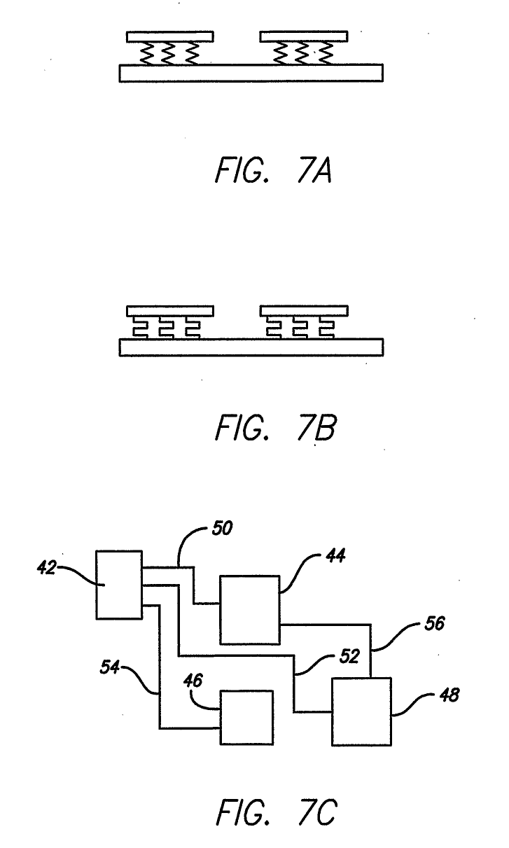

Bent CNTs can also be useful for circuit nano-interconnections as illustrated schematically in FIG. 7 showing electrical components 42, 44, 46 and 48 and nanotube circuit conductors 50, 52, 54 and 56. Vertical nano-interconnections of electronic or optoelectronic components with substantially different coefficient of thermal expansion (CTE) can often result in undesirable stresses caused by thermal expansion mismatch, which can induce fatigue and fracture related failures at connection joints. The zig-zag shaped, springlike nanotubes obtained in this invention, shown in FIGS. 7(a) and 7(b), can conveniently be utilized to accommodate CTE mismatch stresses. For in-plane nano-interconnections, routing of circuit connections often require not just a straight but sharp-turn conductor circuit lines as illustrated in FIG. 7(c). The inventive multiple, sharp bend zig-zag nanotubes are also useful for such applications, especially with SWNTs or small diameter MWNTs, made to respond to electric field manipulations and bend in a similar fashion. The presence of ferromagnetic catalyst particle at the tip (and sometimes inside nanotubes) can be utilized for magnetic manipulation and transport of bent nanotubes for positioning. For finer feature interconnects, SWNTs or small diameter MWNTs (e.g., 2-5 walls) are preferred. Such sharp bends, if introduced in SWNTs, can induce pentagon-heptagon or other types of defects and associated semiconductor heterojunctions for potential nanoelectronics applications.

In summary, this invention describes the structure and fabrication techniques for growth of high-aspect-ratio nanostructures, such as carbon nanotubes with one or multiple bends. The bending of the CNTs during growth was accomplished by changing the direction of the electric field lines in the growth region of the sample, utilizing recessed corner fields of conducting metal blocks. The resulting structures have abrupt, nanoscale sharp bends, and maintain substantially the same tube diameter throughout growth. Catalyst particles are still present at the tops of the zig-zag structures, so that many additional bent segments or other unique three-dimensional structures can be created. Such multiple bent nanotubes can be useful for a variety of applications including mechanical nano-spring devices, high-resolution AFM tips, and nano-circuit interconnections.

For efficient electric field alignment of growing nanowires or nanotubes, stronger electric fields are usually desirable. Such a stronger field in the edge (or protruding corner) of conducting metal elements has thus been employed to obtain a curved nanostructure. The invention described here is new and unique, in that in contrast to prior art teaching of using a stronger field, the inventive method of bending the growing nanowires utilizes directed electric fields with extremely weak electric field intensity present in the recessed corners of electrically conducting elements. The use of recessed corner fields allows for the creation of very sharply bent nanostructure.

### INDUSTRIAL APPLICABILITY

The invention includes novel nanostructures with sharp bends, methods for engineering such bent nanostructures with sharp radii of curvature of less than 100 nm, and devices comprising such nanostructures for applications such as nano interconnections, nano circuit components, nano heterojunction semiconductors, nano solenoids, nano springs and various nano-manipulators/nano-actuators, and nano probes for characterization of surface topography, nano conductance, nanomagnetics, nano-writing/nano-patterning, and nano machining. This inventive method allows for the synthesis of structures with multiple sharp bends i.e. zigzag morphology, box helixes, and others. The inventive method also allows for the continuous fabrication of sharply bent or curved nano-structures without interupping the deposition process, and fabrication of such novel structures over large substrate large areas.

Having thus described the invention, we claim:

1. A method of making one or an array of elongated nanostrnctures attached on a substrate with the nanostructure having one or more sharp bends, using a plasma enhanced chemical vapor deposition process to fabricate a nanostructure sample, comprising, placing an anode above the sample and a cathode below the sample, applying a voltage between the anode and cathode to create electric field lines, and changing the direction of the electric field lines during the fabrication of the nanostructure by placing a metal plate in electrical contact with the cathode, and then moving the location-of the metal plate.

2. The method of claim 1 in which the metal plate is positioned against the cathode to produce a sharp corner and the sample is placed in the sharp corner.

3. The method of claim 2 in which the position of the metal plate and the sample against the cathode is reversed.

4. The method of claim 2 in which the sample is placed in a recessed corner of the contact between the metal plate and cathode.

5. The method of claim 4 in which the metal plate is moved by discontinuous rotation of the metal plate.

6. The method of claim 6 in which the metal plate and the substrate is rotated by positioning it on a continuously rotatable support structure.

7. A method of making a helically shaped, elongated nanostructure comprising, using a plasma enhanced chemical vapor deposition process to fabricate a nanostructure sample, comprising, placing an anode above the sample and a cathode below the sample, applying a voltage between the anode and cathode to create electric field lines, and continuously changing the direction of the electric field lines during the fabrication of the nanostructure by placing a metal plate in electrical contact with the cathode, and then continuously moving the location of the metal plate.

8. The method of claim 7 in which the metal plate is positioned against the cathode to produce a sharp corner and the sample is placed in the sharp corner.

9. An elongated nanostructure of nanowire or nanotube attached on a substrate comprising one or more sharp bends, with a radius of curvature at the sharp bends being less than 200 nm.

10. The sharply bent nanowire or nanotube structure of claim 9 wherein the structure is in a random or periodic array configuration.

11. The sharply bent elongated nanostructure of claim 9 wherein the structure is made of carbon based material.

12. The sharply bent elongated nanostructure of claim 9 wherein the structure consists of a carbon nanotube.

13. One or an array of a continuously direction-changing elongated nanostrncture of nanowire or nanotube attached on a substrate.

14. The continuously direction-changing elongated nanostructure of claim 13 wherein the structure consists of a periodically direction changing, helically shaped nano solenoid.

15. The continuously direction-changing elongated nanostructure of claim 13 wherein the structure is made of carbon based material.

16. A nanoprobe device using the nanostructure of claims 9-15.

17. The nanoprobe of claim 16 wherein the probe performs one of the following functions; atomic force microscopy, magnetic force microscopy, electrical conductance measurements, nanopatterning, nanowriter for information storage using magnetically recorded bits, magneto-optical bits, electron beam ablation written bits, thermally actuated written bits and mechanically indented bits.

18. A nanoscale circuit interconnection structure containing the bent nanostructure of claims 9-15.

19. The nano circuit interconnection structure of claim 18 wherein the interconnection is vertical, compliant, electrical connection between a lower circuit device and upper circuit devices.

20. The nano circuit interconnection structure of claim 18 wherein the interconnection is horizontal, in-plane electrical connection of devices placed on a substrate.

21. A nano solenoid of the bent nanostructure of claims 13-15.

22. A nano-manipulators/nano-actuators comprising one or more of the bent nanostructures of claims 9-15.

23. A method of fabricating elongated nanostructures with one or more sharp bends using a plasma enhanced chemical vapor deposition process comprising placing an anode above the nanostructure and a cathode below the nanostructure, applying a voltage between the anode and cathode to create electric field lines, and changing the direction of the electric field lines during the fabrication of the nanostructure.

24. An elongated nanostructure with one or more sharp bends fabricated using a plasma enhanced chemical vapor deposition process in which an anode is placed above the nanostructure and a cathode is placed below the nanostructure, a voltage is applied between the anode and cathode to create electric field lines, and the direction of the electric field lines are changed during the fabrication of the nanostructure.
